(19) United States
(12) Patent Application Publication
(10) Pub. No.: US 2025/0114268 A1
(43) Pub. Date: Apr. 10, 2025

(54) ACCUPRESSURE COMB

(71) Applicants: Michael Howland, Santa Rosa Beach, FL (US); Genevieve Howland, Santa Rosa Beach, FL (US)

(72) Inventors: Michael Howland, Santa Rosa Beach, FL (US); Genevieve Howland, Santa Rosa Beach, FL (US)

(21) Appl. No.: 18/484,085

(22) Filed: Oct. 10, 2023

(51) Int. Cl. A61H 11/00; A61H 39/04

(52) U.S. Cl. CPC A61H 11/00; A61H 39/04; A61H 2201/0153; A61H 2201/168; A61H 2205/065

(57) ABSTRACT

According to an aspect of the present invention, there is provided a comb, comprising: a comb body, an edge of the comb body comprising two sides and a central portion, and a plurality of teeth extending from the central portion of the edge of the comb body, wherein the teeth of the comb are placed at angle configured to hit acupressure points on a hand of a user.

### BACKGROUND

Combs for massaging the scalp of a person are well-known in the patent literature.

For example, U.S. Pat. No. 8,347,895 discloses a massage comb and fluid application combination for use on a scalp of a user including an upper section and a lower removable section, said lower section has several teeth depending therefrom, said lower section having a treatment fluid contained therein, said lower section is being made of a bamboo material which will allow said treatment fluid to permeate through said material and transfer said treatment fluid to strands of hair, wherein said upper and lower sections are held together by way of a dove tail arrangement and wherein each of said teeth of said lower section has a through aperture therein and a tip with an opening to apply said treatment fluid to a scalp of a user.

US20170290733 discloses a magnetic elastic hairdressing massage comb, comprising a hollow shell, an electric heating device and an electric source wire, wherein a circle of non-electric conductive adiabatic outer gears with a certain interval space are set around a working face of the shell, a comb body heat conductive layer is arranged at the inner of the non-electric conductive adiabatic gear circle, on which several lattice arrayed magnetic elastic moving gears are set, the said magnetic elastic moving gears are hollow heat conductive gears, each of the said magnetic elastic moving hollow heat conductive gears comprises a hollow heat conductive gear body, a heat resistant magnetic body X fixed in the bottom of the hollow heat conductive gear body, a movable heat resistant magnet body Y is set on the upside of magnetic body X by face to face with the same pole, and a high temperature-resistant adiabatic column connected on the upside of the magnetic body Y, the high temperature-resistant adiabatic column stretches out of an opening of the top of said hollow heat conductive gears; and the bottom side of heat conductive comb body connects with an electric heating device and an electric source wire both of which is arranged in the shell.

US20220142852 discloses a massage comb includes a comb body, a handle, a plurality of teeth, and a rolling bead. The handle is disposed below the comb body and integrated with the comb body, the plurality of teeth are arranged on the comb body at intervals, and the rolling bead is rollably disposed at the end of the handle. Since the massage comb is provided with rolling bead at the end of the handle, before or after combing the hair, the rolling bead can be used to massage the acupuncture points in the head, which facilitates opening the head meridian and enhancing blood circulation in the head. In addition, the rolling bead is arranged at the end of the handle, so that the massage comb of the present invention has a dual-purpose effect.

However, combs which are suitable for acupressure applications for other body parts are needed.

### SUMMARY OF INVENTION

Therefore, the present invention provides a natural way to manage pain by using acupressure and the gate control theory to reduce the perceived intensity of pain and/or anxiety.

According to an aspect of the present invention, there is provided a comb, comprising: a comb body, an edge of the comb body comprising two sides and a central portion, and a plurality of teeth extending from the central portion of the edge of the comb body, wherein the teeth of the comb are placed at angle configured to hit acupressure points on a hand of a user.

According to another aspect of the present invention, there is provided a method of relieving pain, comprising: providing a comb body, providing an edge of the comb body comprising two sides and a central portion; providing a plurality of teeth extending from the central portion of the edge of the comb body; and applying the comb to the hand of a user, wherein the teeth of the comb are placed at angle configured to hit acupressure points on a hand of a user.

### BRIEF DESCRIPTION OF THE DRAWINGS

FIG. 1 illustrates a comb according to an embodiment of the present invention.

### DETAILED DESCRIPTION

A birth comb according to the present invention provides a natural way to manage labor intensity during childbirth by using acupressure and the gate control theory to reduce the perceived intensity of labor pain.

Mothers can use the birth comb postpartum and during breastfeeding to enjoy similar relief from pain. Embodiments of the present invention are not limited to maternity applications however and can also be used for other occasions where acupressure relief may be handy, such as a visit to the dentist, getting a tattoo, or any situation where it is desirable to relieve anxiety and enjoy distraction from pain.

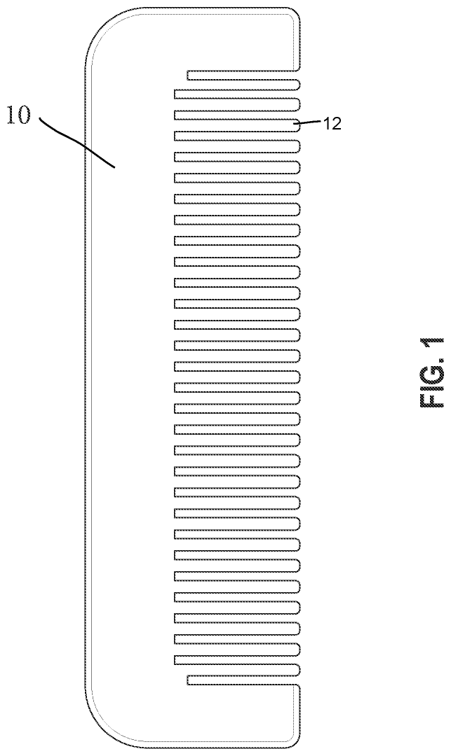

FIG. 1 illustrates comb body 10 having an edge on a bottom and two lateral sides of the comb, and teeth 12 extending from the bottom edge of comb body 10.

The comb can be made from a single piece of high-quality pear wood, which is naturally durable and is ergonomically designed to fit comfortably in a user's hand.

The teeth of the comb according to embodiments are placed at an optimal angle to hit acupressure points on your hand, providing maximum relief.

When a user holds a comb according to an embodiment, the user keeps the teeth pointing just below where the user's fingers meet the user's palm, and the size and shape of the comb are optimized for this purpose, along with the angle at which the teeth extend from the base. The dimensions of the comb ¼ to ¾ thick, 5 to 8 inches long, and with teeth extending 4 to 6 inches from the bottom edge of the comb body are critical to its effectiveness.

For example, a comb according to an embodiment can be used when a user feels a contraction coming. The user can close the user's fist around the comb and let the teeth press into the user's palm. The user can use as much or as little pressure as the user desires.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A comb, comprising:
a comb body,
an edge of the comb body comprising two sides and a central portion, and
a plurality of teeth extending from the central portion of the edge of the comb body,
wherein the teeth of the comb are placed at angle configured to hit acupressure points on a hand of a user.

2. The comb of claim 1, wherein the comb body and teeth are made of a material comprising pear wood.

3. The comb of claim 1, wherein the comb body and teeth are made of a material comprising bamboo.

4. The comb of claim 1, wherein the comb body and teeth are made of a material comprising metal.

5. The comb of claim 1, wherein the comb body and teeth are made of a material comprising plastic.

6. The comb of claim 1, wherein the comb body and teeth are ¼ to ¾ inches thick.

7. The comb of claim 1, wherein the comb body is 5 to 8 inches long.

8. The comb of claim 1, wherein the comb body and teeth extend 4 to 6 inches from the bottom edge of the comb body.

9. A method of relieving pain, comprising:
providing a comb body,
providing an edge of the comb body comprising two sides and a central portion;
providing a plurality of teeth extending from the central portion of the edge of the comb body; and
applying the comb to the hand of a user, wherein the teeth of the comb are placed at angle configured to hit acupressure points on a hand of a user.

10. The method of claim 9, further comprising customizing the sizing of the comb for the individual user.
